(19) United States
(12) Patent Application Publication
(10) Pub. No.: US 2026/0220290 A1
(43) Pub. Date: Jul. 30, 2026

(54) PROVISIONING FOR SYSTEM INTEGRATIONS

(71) Applicant: Veza Technologies, Inc., Los Gatos, CA (US)

(72) Inventors: Maohua Lu, Fremont, CA (US); Tarun Thakur, Los Gatos, CA (US); Marc Olin, Minneapolis, MN (US)

(21) Appl. No.: 19/464,172

(22) Filed: Jan. 29, 2026

Related U.S. Application Data
(60) Provisional application No. 63/750,841, filed on Jan. 29, 2025.

(51) Int. Cl. G06F 21/62; G06F 11/3668

(52) U.S. Cl. CPC G06F 21/6218; G06F 11/3684; G06F 11/3688

(57) ABSTRACT

The technology disclosed herein enables automatic provisioning capability add-on of read-only existing integrations for data environments. In a particular example, a method provides identifying an existing integration for a user of the plurality of data environments. The method further provides receiving user input with a definition of a provisioning with respect to the existing integration and autogenerating instructions that define tasks for implementing the definition. The method also provides executing the instructions in the plurality of data environments.

### RELATED APPLICATION

This application is related to and claims priority to U.S. Provisional Patent Application 63/750,841, titled “IMPROVED PROVISIONING FOR SYSTEM INTEGRATIONS,” filed January 29, 2025, which is hereby incorporated by reference in its entirety.

### TECHNICAL BACKGROUND

The effectiveness of LifeCycle Management (LCM) is largely dependent on the number of integrations it can accommodate. An integration is the process of connecting different software applications or systems so they can work together seamlessly. This enables access provisioning and coordination of workflows between applications, allowing for improved efficiency and automation in managing their lifecycle processes. An LCM platform must be capable of supporting a diverse array of applications across various functions and departments. No single individual or team possesses a comprehensive understanding of all these applications, necessitating each department independently onboard its own applications to the LCM platform. Consequently, the speed at which LCM integrations can be added is crucial for realizing the benefits of LCM. The quicker each department can implement their integrations, the broader the spectrum of applications the LCM platform can automate in terms of provisioning and deprovisioning.

### SUMMARY

The technology disclosed herein enables automatic provisioning capability add-on of read-only existing integrations for data environments. In a particular example, a method provides identifying an existing integration for a user of the plurality of data environments. The method further provides receiving user input with a definition of a provisioning with respect to the existing integration and autogenerating instructions that define tasks for implementing the definition. The method also provides executing the instructions in the plurality of data environments.

In another example, an apparatus is provided having one or more computer readable storage media and a processing system operatively coupled with the one or more computer readable storage media. Program instructions stored on the one or more computer readable storage media, when read and executed by the processing system, direct the apparatus to perform the steps of the above-recited method.

### BRIEF DESCRIPTION OF THE DRAWINGS

FIG. 1 illustrates an implementation for automatically provisioning capability add-on of existing read-only integrations for users of data environments.

FIG. 2 illustrates an operation to automatically provision integrations for users of data environments.

FIG. 3 illustrates an operational scenario to automatically provision integrations for users of data environments.

FIG. 4 illustrates an operation to automatically provision integrations for users of data environments.

FIG. 5 illustrates an operational scenario to automatically provision integrations for users of data environments.

FIG. 6 illustrates a privilege graph for automatically provisioning integrations for users of data environments.

FIG. 7 illustrates a computing architecture for automatically provisioning integrations for users of data environments.

### DETAILED DESCRIPTION

The technology described below adds provisioning and/or deprovisioning capabilities on top of base integrations between two or more entities. Typically, base integrations only support read of authorization metadata to ensure data integrity and security. By limiting interactions to read-only access, the system can prevent unintended modifications that could lead to errors or inconsistencies in the metadata. This approach simplifies the integration process, as it reduces the complexity associated with managing write permissions and maintaining data synchronization across different applications. Additionally, focusing on read operations allows for efficient monitoring and reporting of metadata without the risks associated with altering the underlying data structures.

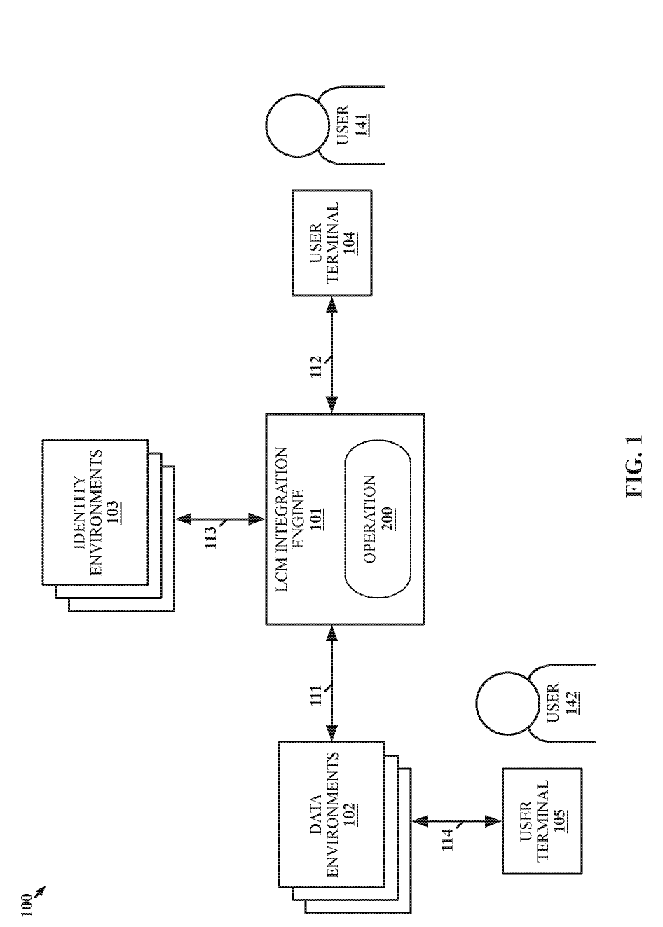

FIG. 1 illustrates implementation 100 for automatically provisioning capability add-on of existing read-only integrations for users of data environments. Implementation 100 includes LCM integration engine 101, data environments 102, identity environments 103, user terminal 104, and user terminal 105. LCM integration engine 101 and data environments 102 communicate over respective communication links 111. LCM integration engine 101 and user terminal 104 communicate over communication link 112. LCM integration engine 101 and user terminal 105 communicate over communication link 114. LCM integration engine 101 and identity environments 103 communicate over respective communication links 113. While communication links 111-114 are shown as direct links, communication links 111-113 may include intervening systems, networks, and/or devices. LCM integration engine 101 executes on one or more computing systems, such as server systems, having processing and communication circuitry to operate as described below. User terminals 104 and 105 are each a user operated computing system, such as a desktop workstation, laptop, tablet computer, smartphone, etc. User terminal 104 is operated by an administrative user 141 that configures LCM integration engine 101. User terminal 105 is operated by a user who accesses resources provided by data environments 102.

In operation, LCM integration engine 101 performs operation 200 to automatically configure integrations in data environments 102. Data environments 102 include one or more systems that host databases, such as databases for Online Transaction Processing (OLTP) and Online Analytical Processing (OLAP), tables, files, applications, or other computing resources provided to accessing systems — including combinations thereof. Identity environments 103 include one or more systems that maintain information about users (e.g., user identity information, user attributes, etc.) and may include information about which of data environments 102 (including specific resources therein) each user is allowed to access. Identity environments 103 may include an active directory (AD) server, an Okta® system, an Identity and Access Management (IAM) system, a privilege access management (PAM) system, human resources management system (HRMS), identity and access governance (IAG) system, or any other type of system that maintains the user information discussed above. Identity environments 103 maintain identity information about users that may access one or more of data environments 102. The identity information may include authorization information indicating whether given users are allowed to access certain resources provided by data environments 102 or ones of data environments 102 as a whole. In some examples, a data environment of data environments 102 may authorize a user itself based on identity information for the user included in identity environments 103. For instance, identity environments 103 may indicate information about a user, such as a work group for the user, the user’s job title/role, a seniority of the user, a security clearance level for the user, or any other type of information that may affect which of data environments 102 the user can access. In further examples, a data environment of data environments 102 may authorize users independently. While a user, like user 142, is primarily considered a human user herein, a user of a data environments 102 may be a computing system, application, service, or some other entity for accessing information/resources in data environments 102.

LCM integration engine 101 takes existing base integrations within data environments 102, which only allow metadata reads, and automatically takes the necessary actions to provision additional privileges. As such, user 141 only need create the base integration manually but can then rely on LCM integration engine 101 to perform the needed configuration of what could be many different systems within data environments 102 to provision write access for a user to the base integration. For example, a user may be newly hired by a business using data environments 102. User 141 may instruct LCM integration engine 101 to give the new user access to certain resources of data environments 102. Similarly, when a user leaves the business, user 141 may instruct LCM integration engine 101 to deprovision the access from the departing user.

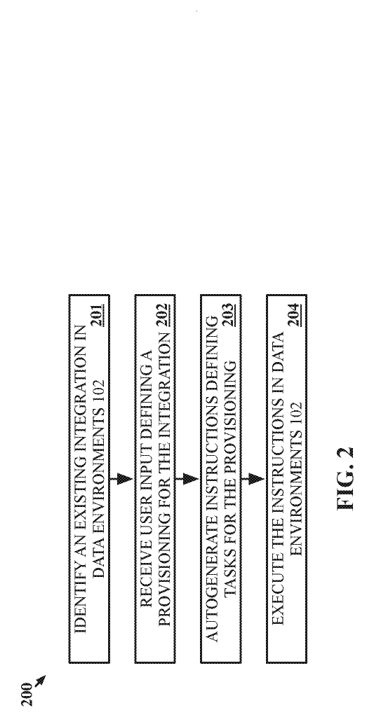

FIG. 2 illustrates operation 200 to automatically provision integrations for users of data environments. In operation 200, LCM integration engine 101 identifies an existing integration for user 142 (step 201). The existing integration will be the base integration that will be configured by LCM integration engine 101. The existing integration may be one of many base integrations in data environments 102. In some examples, the existing integration may not be identified until after user 141 defines the provisioning (e.g., adding a user) or deprovisioning (e.g., removing a user) that should occur. LCM integration engine 101 may identify the existing integration, or integrations, that are relevant to the definition.

The existing integration may be captured in a privilege graph that connects nodes representing users to nodes representing resources (e.g., files, tables, services, applications, etc.) of data environments 102. Intervening attribute nodes of the privilege graph between the users and the resources indicate attributes of the users connected to the attribute nodes. The privilege graph, therefore, indicates which users should have access to which resources of data environments 102.

LCM integration engine 101 receives from user 141, user input with a definition of a provisioning (or deprovisioning) with respect to the existing integration (step 202). The input in this case provided by user 141 into user terminal 104, which is communicatively coupled with LCM integration engine 101. User terminal 104 may execute a client application for interfacing with LCM integration engine 101, may access LCM integration engine 101 through a browser interface, or may interact with LCM integration engine 101 in some other manner.

In this example, provisioning involves creating a new entity, such as an employee or user account, for user 142 within data environments 102. The definition may include entity name, an Application Programming Interface (API) to create the entity, new relationship that needs to be created from the entity to other existing entities (e.g., group, role, etc.), and APIs to create the relationship. Similarly, deprovisioning involves the removal or deactivation of an entity, such as when an employee leaves the organization. In the case of deprovisioning, the definition may include the entity name to deprovision, an API to remove the entity, affected relationships with existing entities, and (optionally) APIs to remove the relationships. Whether provisioning or deprovisioning, the definition provides LCM integration engine 101 with the information it needs to identify which elements of data environments 102 will be affected by the addition or removal of the entity.

LCM integration engine 101 then autogenerates instructions that define tasks for implementing the definition (step 203). The instructions may be code that defines tasks that are sent to a provisioning or deprovisioning job queue. The instructions are executed data environments 102 (step 204). In examples using a privilege graph, LCM integration engine 101 may be updated to reflect the provisioning or deprovisioning that occurred.

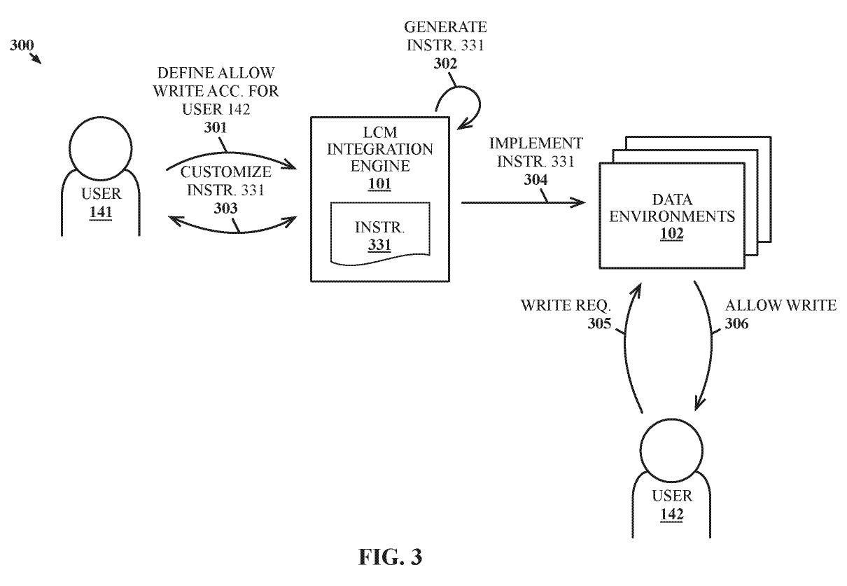

FIG. 3 illustrates operational scenario 300 to automatically provision integrations for users of data environments. In operational scenario 300, user 141 defines in LCM integration engine 101 that write access is desired for user 142 (step 301). LCM integration engine 101 generates integration instructions 331 to implement the defined write access for user 142 (step 302). In this example, prior to implementing integration instructions 331, LCM integration engine 101 presents integration instructions 331 to user 141 (e.g., via an interface at user terminal 104) enabling user 141 to customize integration instructions 331 (step 303). Customizing may include removing instructions from integration instructions 331, adding instructions to integration instructions 331, modifying instructions in integration instructions 331, or some other change to integration instructions 331 desired by user 141. After customization, LCM integration engine 101 implements the instructions by performing the tasks therein in applicable systems of data environments 102 (step 304). For example, LCM integration engine 101 may make an API call to a system of data environments 102 to which user 142 will have access (e.g., to the system as a whole or a component of the system, such as a folder or table stored therein). The API call may be used to configure the system to accept requests from user 142 (e.g., from an entity name representing user 142). Thus, when the system receives a write request from user 142 (step 305), the system allows that write request (step 306).

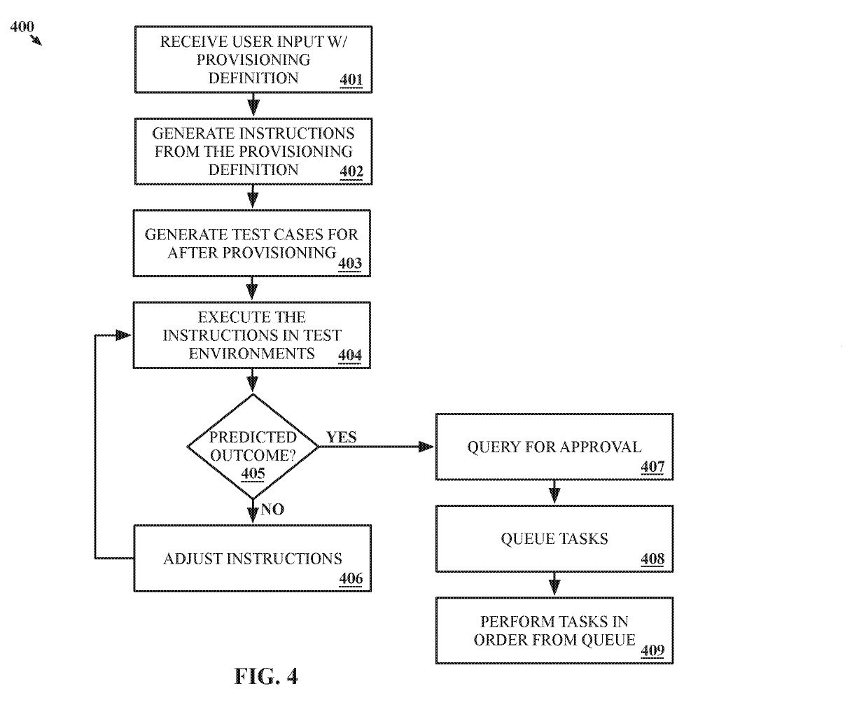

FIG. 4 illustrates operation 400 to automatically provision integrations for users of data environments. In operation 400, LCM integration engine 101 receives user input from user 141 defining the desired provisioning (step 401). The user input can be provided through a graphical interface, a command-line interface, a configuration file, or a programmatic application programming interface (API). The user input may include identification of a target capability (e.g., “grant write access to dataset X,” “create service account Y and bind role Z”), identification of entities to be created or removed (e.g., user accounts, service principals, groups, roles, policies, application registrations), relationships to be created or removed (e.g., membership in a group, assignment of a role to a principal, attachment of a policy to a resource), and references to APIs or connectors that implement the operations in data environments 102. In some examples, the user input is expressed in a low‑code template that captures, in fields, the entities, relationships, scopes, and API endpoints. In other examples, the user input comprises a natural‑language description that is interpreted by a rules engine or machine learning model to produce a structured provisioning definition. LCM integration engine 101 may automatically augment or validate the provisioning definition using identity environments 103 (e.g., resolving approvers, managers, or application owners; resolving a group’s canonical identifier) and using metadata discovered from data environments 102 (e.g., verifying resource identifiers and available permission types).

LCM integration engine 101 generates instructions from the provisioning definition (step 402). The instructions can include an ordered sequence of tasks, each task corresponding to an operation such as create‑principal, add‑membership, grant‑role, attach‑policy, create‑schema‑object, set‑quota, or update an access control list. Dependencies among tasks can be encoded so that a prerequisite task is executed before its dependents (e.g., create the user before adding the user to a group). In some implementations, LCM integration engine 101 generates a portable intermediate representation (IR) of the instructions that is then translated to target‑specific commands for respective data environments 102. The instructions may be derived from provisioning templates matched to application categories (e.g., database, object store, SaaS application, message queue) and can include preconditions, postconditions, target API surfaces, resource scopes (e.g., project, schema, folder), and expected outcome predicates for later verification. Credentials and connection parameters may be associated with tasks but stored externally in a secret store to avoid embedding secrets in the instruction payload.

LCM integration engine 101 generates test cases that will ensure the provisioning is properly implemented (step 403). Test cases may be autogenerated from the provisioning definition and from a library of patterns. Examples include state‑verification checks (e.g., confirm the presence of the newly created principal; confirm a group membership exists), permission probes (e.g., attempt read, write, or administrative operations that should be allowed), and negative controls (e.g., attempt operations beyond the requested scope that should be denied). In some examples, test cases cover edge conditions, such as idempotent creates when the entity already exists, conflict resolution when a principal is already bound to a different role, and constrained scopes (e.g., a grant limited to a particular dataset or path). Coverage targets can be computed from the instruction IR to ensure that each task has a corresponding verification or negative test.

LCM integration engine 101 executes the instructions in a test environment to avoid potentially disrupting the production environments (step 404). The test environment may be an isolated tenant, a sandbox or staging instance, a namespace or project dedicated to testing, or a simulation harness that replays API responses without committing state. Where feasible, the same APIs used for production are invoked against test endpoints to maximize fidelity. Credentials used for testing can be scope‑limited, time‑limited, or both, and LCM integration engine 101 may mask or redact test data to protect sensitive information.

LCM integration engine 101 then performs the test cases in the test environments to determine whether the integrations produce predicted (or expected) results for the test cases (step 405). Predicted results may be derived from the expected outcome predicates annotated on the instruction IR or from a dry‑run evaluation against a privilege graph model that computes effective permissions before any write is performed. If the observed outcomes do not match the predicted outcomes, LCM integration engine 101 adjusts the instructions (step 406). Adjustments may include reordering tasks to satisfy dependencies, inserting prerequisite steps (e.g., create or enable a missing group, policy, or service account), selecting an alternate connector or API version, changing a scope boundary (e.g., from organization to project), narrowing a permission to achieve least‑privilege, or updating parameter values based on environment feedback. Adjustments may be generated automatically, suggested for approval, or applied directly by an administrative user through a customization interface that edits the instruction IR and immediately regenerates affected test cases.

In this example, if the predicted outcomes occur, LCM integration engine 101 queries an approver‑user, which may be user 141 who provided the definition or another user, to confirm the instructions can be implemented in production (step 407). The approver can be identified from identity environments 103 based on roles (e.g., application owner, resource owner, security administrator), management hierarchy (e.g., the requester’s manager), group membership (e.g., members of a designated approval group), or policy rules (e.g., approval is automatic for non‑production targets within a preapproved template). The approval can be obtained via an in‑product notification, an email workflow, a ticketing system integration, or a programmatic approval endpoint. Before queuing, LCM integration engine 101 may also perform a policy‑conflict evaluation using organization or application policies. If a conflict is detected—such as the instructions granting a permission that violates a constraint—LCM integration engine 101 can suggest a modification, automatically resolve the conflict by selecting a lower‑privilege alternative, or block execution until a policy override is approved in accordance with organizational rules.

Upon receiving approval to proceed, LCM integration engine 101 queues instruction tasks in a queue (step 408). The queue can be implemented as a first‑in‑first‑out (FIFO) queue, a priority queue that favors urgent remediation tasks, or a partitioned queue that isolates workloads per tenant, per application, or per data environment to honor rate limits and maintenance windows. Tasks may include explicit ordering constraints that ensure dependent tasks are processed after their prerequisites. The queue can optionally attach scheduling metadata (e.g., allowed time windows for change control) and throttling parameters. The tasks are performed in data environments 102 from the queue (step 409). In some examples, multiple workers may process tasks concurrently while LCM integration engine 101 enforces ordering guarantees within a provisioning plan. LCM integration engine 101 can apply a retry policy for transient failures, enforce request pacing to comply with rate limits, and record detailed execution telemetry for auditing and diagnostics. Where a task targets an environment that becomes unavailable, LCM integration engine 101 may pause the corresponding partition while allowing unrelated partitions to continue.

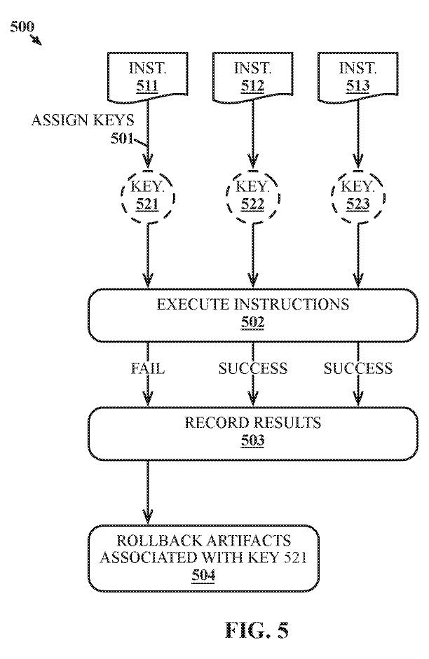

FIG. 5 illustrates operational scenario 500 to automatically provision integrations for users of data environments. In this example, three instructions 511‑513 were generated by LCM integration engine 101. LCM integration engine 101 assigns idempotency keys 521‑523, or other types of identifiers, to the respective instructions 511‑513 (step 501). The idempotency keys can incorporate a plan identifier, a step type, subject and resource identifiers, and a version or timestamp such that repeated deliveries of the same instruction are recognized and deduplicated. In some examples, keys are recorded in a task ledger that maps each instruction to its key, plan version, execution status (e.g., pending, success, failed, compensating, rolled back), timestamps, and references to any artifacts created during execution (e.g., identifiers of principals, memberships, grants, or policies). The keys can also be embedded in the created artifacts as tags or metadata where supported, enabling selective identification of artifacts for rollback and future maintenance.

LCM integration engine 101 executes instructions 511‑513 in data environments 102 (step 502). Execution includes invoking APIs of respective data environments with authenticated requests. LCM integration engine 101 may retrieve credentials from a secret store, scope the credentials to the minimal required permissions, and rotate or revoke credentials after use where appropriate. For each instruction, LCM integration engine 101 can perform a read‑back verification against the target system to confirm that the intended effect was applied (e.g., the membership exists; the grant is effective for the intended resource scope). LCM integration engine 101 records results of the instruction execution (step 503). Recorded results can include success or failure codes, error messages, response payloads, and a list of artifacts created or modified. The ledger enables safe retries for transient errors, avoids duplicate application of the same change, and provides an auditable history.

In this case, execution of instruction 511 fails. LCM integration engine 101 rolls back artifacts associated with key 521 created from the execution of instruction 511 (step 504). During rollback, LCM integration engine 101 identifies artifacts tagged to key 521 and plan version and issues compensating operations to remove or disable those artifacts while preserving artifacts that preexisted the plan or that were created by other instructions or later plan versions. Where a system does not permit deletion, LCM integration engine 101 may disable access (e.g., remove a binding while leaving the principal intact) to restore the prior effective‑permission state. Compensating actions can be ordered in reverse of the successful execution order to respect dependencies (e.g., remove a grant before removing the principal that received the grant). LCM integration engine 101 may also detect stale or out‑of‑order retries and, based on the plan version encoded in the key, skip application of operations that correspond to superseded plans. Selective rollback based on idempotency keys reduces the risk of removing unrelated entitlements and facilitates clean recovery from partial failures.

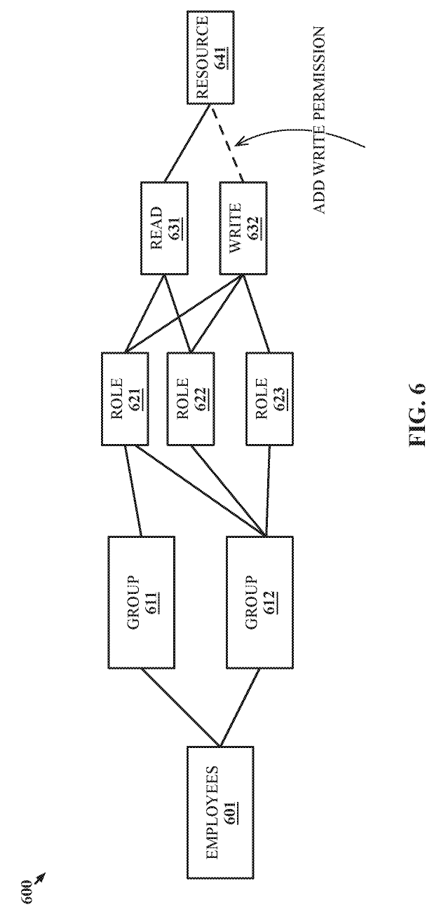

FIG. 6 illustrates privilege graph 600 for automatically provisioning integrations for users of data environments. Privilege graph 600 is at least a portion of a privilege graph used by LCM integration engine 101 to determine privileges various integrations have in data environments 102 and to compute the minimal set of changes that will enable a requested capability. Privilege graph 600 includes nodes that represent users or other identities (e.g., service accounts, groups as principals) sourced from identity environments 103, attribute nodes that represent authorization properties (e.g., groups, roles, policies, capabilities), and resource nodes that represent target resources in data environments 102 (e.g., applications, databases, tables, schemas, object store buckets, file paths, queues, or services). Directed edges indicate authorization relationships, and in some implementations the edges are typed to distinguish membership, role assignment, policy attachment, inheritance, delegation, and effective‑permission derivations. Edges may also carry attributes such as scope, conditions, expiration times, or constraints (e.g., a grant limited to a project or dataset).

Tracing privilege graph 600 from employees node 601 through the attribute nodes representing attributes of an employee of interest indicates a privilege the employee has with respect to the resource represented by resource node 641. In this example, privilege graph 600 can be traced through group nodes 611‑612 representing respective groups within an entity having the employees. From group nodes 611‑612, privilege graph 600 can be traced through role nodes 621‑623. According to privilege graph 600, employees associated with group node 611 can only reach role node 621 while employees associated with group node 612 can reach role nodes 621‑623. If the traversal of privilege graph 600 goes through read node 631, then an employee having all the traversed attributes can read whichever resource(s) are connected to read node 631. Only resource node 641 is shown in this example but any number of resource nodes may branch from read node 631 depending on configured permissions. In other examples, additional attributes such as geography, department, project, clearance level, or time‑bounded conditions can be represented as attribute nodes or edge properties that constrain reachable edges and thus restrict effective permissions.

In this example, a base integration may only enable read permissions for the resource in data environments 102 represented by resource node 641. After integration instructions are executed, write permissions are granted to the resource and privilege graph 600 may be updated to show the branch from write node 632 to resource node 641. The update can include adding new edges from relevant role or group nodes to write node 632 and from write node 632 to resource node 641 or modifying existing edges to reflect a change in scope such as narrowing a grant from organization scope to project scope. In some examples, LCM integration engine 101 computes a least‑privilege subgraph that satisfies the target capability defined at step 401 and emits instructions based on the difference between the current graph and the least‑privilege subgraph. After execution, LCM integration engine 101 can confirm consistency by querying data environments 102 to verify creation of the entities and authorization relationships represented in the updated graph, and by running negative checks to confirm that non‑requested permissions remain denied.

Alternatives may be used without departing from the scope of these examples. The test environment mentioned in operation 400 may be implemented as a dedicated tenant, a namespace or project with production‑like controls, a replay or simulation mode that evaluates instructions against recorded or sampled metadata, or a shadow‑write mechanism in which proposed changes are staged but not committed. The approval step may be manual, policy‑driven, or hybrid, and approvals may require multiple approvers or a quorum. Approvers may be identified by role, resource ownership, management chain, or membership in an authorization group within identity environments 103, and approvals may expire if execution does not commence within a time window. The queueing step may use a single global queue, per‑environment queues, or tenant‑partitioned queues with independent schedulers to isolate workloads. The instruction IR may support versioning so that updates to a provisioning definition create a new plan version; LCM integration engine 101 can then ignore stale retries from a prior plan and, if needed, roll back artifacts associated with the prior plan while applying the new plan. Retry policies can be applied for transient errors, while persistent errors can be escalated for manual remediation with diagnostic context. The privilege graph may be persisted in a graph database, encoded in relational tables, or maintained in memory. The graph may include node and edge tagging for tenancy, ownership, audit lineage, and time‑bounded validity. In situations where a data environment supports deny rules, the graph may model deny relationships as higher‑priority edge types so that effective permissions are computed correctly when both allow and deny relationships exist.

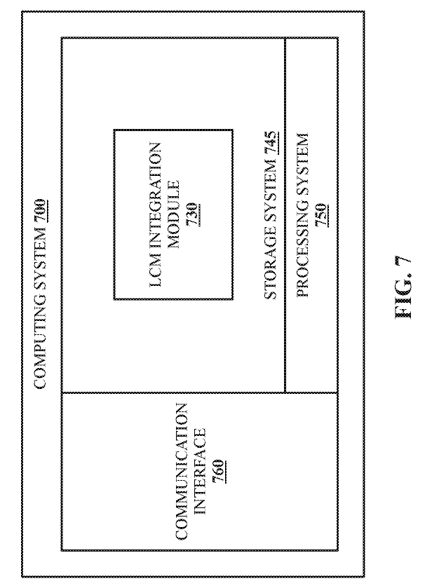

FIG. 7 illustrates computing system 700 for automatically provisioning integrations for users of data environments. Computing system 700 is representative of any computing system or systems with which the various operational architectures, processes, scenarios, and sequences disclosed herein can be implemented. Computing system 700 is an example architecture for LCM integration engine 101, data environments 102, identity environments 103, user terminal 104, and user terminal 105, although other examples may exist. Computing system 700 includes storage system 745, processing system 750, and communication interface 760. Processing system 750 is operatively linked to communication interface 760 and storage system 745. Communication interface 760 may be communicatively linked to storage system 745 in some implementations. Computing system 700 may further include other components such as a battery and enclosure that are not shown for clarity.

Communication interface 760 comprises components that communicate over communication links, such as network cards, ports, radio frequency (RF), processing circuitry and software, or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or some other communication format – including combinations thereof. Communication interface 760 may be configured to communicate with other computing systems via one or more networks.

Processing system 750 comprises microprocessor and other circuitry that retrieves and executes operating software from storage system 745. Storage system 745 may include volatile and nonvolatile, removable, and non-removable media implemented in any method or technology for storage of information, such as computer readable instructions, data structures, program modules, or other data. Storage system 745 may be implemented as a single storage device but may also be implemented across multiple storage devices or sub-systems. Storage system 745 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no interpretations would storage media of storage system 745, or any other computer-readable storage medium herein, be considered a transitory form of signal transmission (often referred to as "signals per se"), such as a propagating electrical or electromagnetic signal or carrier wave.

Processing system 750 is typically mounted on a circuit board that may also hold the storage system. The operating software of storage system 745 comprises computer programs, firmware, or some other form of machine-readable program instructions. The operating software of storage system 745 comprises LCM integration module 730. The operating software on storage system 745 may further include an operating system, utilities, drivers, network interfaces, applications, or some other type of software. When read and executed by processing system 750 the operating software on storage system 745 directs computing system 700 to automatically provision LCM integrations as described herein. LCM integration module 730 may execute natively on processing system 750 or the operating software may include virtualization software, such as a hypervisor, to virtualize computing hardware on which LCM integration module 730 executes.

In at least one example, LCM integration module 730 executes on processing system 750 and directs processing system 750 to identify an existing integration for a user of the plurality of data environments. LCM integration module 730 further directs processing system 750 to receive user input with a definition of a provisioning with respect to the existing integration and autogenerating instructions that define tasks for implementing the definition. LCM integration module 730 also directs processing system 750 to execute the instructions in the plurality of data environments.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

What is claimed is:

1. A method for adding authorizations to base integrations for a plurality of data environments, comprising:
identifying an existing integration for a user of the plurality of data environments;
receiving user input with a definition of a provisioning with respect to the existing integration;
autogenerating instructions that define tasks for implementing the definition; and
executing the instructions in the plurality of data environments.

2. The method of claim 1, comprising:
testing the instructions to ensure a predicted provisioning outcome will occur.

3. The method of claim 2, comprising:
autogenerating test cases;
executing the instructions on test environments; and
determining the test cases produce the predicted provisioning outcome before executing the instructions in the plurality of data environments.

4. The method of claim 1, comprising:
presenting the instructions to an administrative user for customization; and
receiving edits to the instructions from the administrative user, wherein the instructions are executed after receiving the edits.

5. The method of claim 1, wherein:
receiving the user input comprises receiving an indication of a target capability; and
autogenerating the instructions comprises deriving a least‑privilege set of permissions and relationships in a privilege graph to enable the target capability.

6. The method of claim 1, comprising:
encoding each of the instructions with an idempotency identifier;
recording, in association with the idempotency identifier, a result of executing each of the instructions;
detecting a partial execution of the instructions; and
performing a rollback procedure that identifies entities and relationships created by the partial execution using the idempotency identifiers and removes the entities and the relationships.

7. The method of claim 1, comprising:
routing the instructions for approval to an approver identified from an identity environment; and
executing the instructions in response to receiving the approval from the approver.

8. The method of claim 1, comprising:
detecting, prior to execution, a conflict between the instructions and an existing authorization policy for a data environment; and
modifying the instructions to resolve the conflict based on a policy precedence rule.

9. The method of claim 1, wherein receiving the user input comprises:
receiving a low‑code definition that identifies an entity to be created or removed, relationships to be created or removed, and application programming interfaces to invoke for creation or removal.

10. The method of claim 1, wherein receiving the user input comprises:
receiving a natural‑language description of the provisioning; and
using a large language model to interpret the natural‑language description into a structured definition from which the instructions are autogenerated.

11. The method of claim 1, wherein:
autogenerating the instructions comprises generating tasks for a job queue; and
executing the instructions comprises dequeuing the tasks from the job queue and invoking application programming interfaces of respective data environments corresponding to the tasks in order of dequeuing.

12. The method of claim 1, comprising:
after executing the instructions, updating a privilege graph to reflect newly created entities and relationships, wherein the privilege graph includes:
a privilege graph having a graph structure that includes user nodes corresponding to identities from an identity environment, includes resource nodes corresponding to resources in the plurality of data environments, and directed edges between the user nodes and the resource nodes through attribute nodes corresponding to user attributes.

13. A method for provisioning access across a plurality of data environments, comprising:
identifying authorization metadata for an existing integration that permits read access to resources of the plurality of data environments;
receiving a definition that specifies changes to authorization relationships associated with the existing integration;
automatically generating executable tasks based on the definition that add or remove the authorization relationships; and
executing the executable tasks to provision access to the resources without modifying the authorization metadata of the existing integration.

14. The method of claim 13, wherein the authorization metadata comprises role definitions, group memberships, or policy rules read from the plurality of data environments.

15. The method of claim 13, wherein automatically generating the executable tasks comprises:
generating application‑specific instructions compatible with different ones of the plurality of data environments.

16. The method of claim 13, comprising:
after executing the executable tasks, validating that access is provisioned by issuing a write request to a resource of a data environment and confirming authorization of the write request.

17. A apparatus for extending a read‑only integration to support provisioning operations, the system comprising:
one or more computer readable storage media;
a processing system operatively coupled with the one or more computer readable storage media; and
program instructions stored on the one or more computer readable storage media that, when read and executed by the processing system, direct the apparatus to:
maintain a representation of authorization relationships derived from a read‑only integration;
receive user input describing provisioning or deprovisioning actions with respect to the authorization relationships;
translate the user input into a set of write operations that are external to the read‑only integration; and
execute the write operations to apply the provisioning or deprovisioning actions while preserving the read‑only integration.

18. The apparatus of claim 17, wherein to maintain the representation, the program instructions direct the apparatus to:
store a privilege graph that models users, resources, and authorization relationships derived from the read‑only integration.

19. The apparatus of claim 17, wherein to execute the write operations, the program instructions direct the apparatus to:
invoke identity‑management or resource‑management application programming interfaces distinct from interfaces used by the read‑only integration.

20. The apparatus of claim 17, wherein the program instructions further direct the system to:
audit execution of the write operations by recording which provisioning or deprovisioning actions were applied, when the actions were applied, and identities associated with approving the actions.
